(19) United States
(12) Patent Application Publication
(10) Pub. No.: US 2022/0411636 A1
(43) Pub. Date: Dec. 29, 2022

(54) METHOD FOR THE PREPARATION OF BITUMEN AND INTERMEDIARY COMPOSITIONS

(71) Applicant: TOTALENERGIES ONETECH, Courbevoie (FR)

(72) Inventors: Stefan OEST, Itzehoe (DE); Soenke SCHROEDER, Itzehoe (DE); Thomas ANDRESEN, Hochdonn (DE)

(73) Assignee: TOTALENERGIES ONETECH, Courbevoie (FR)

(21) Appl. No.: 17/777,351

(22) PCT Filed: Dec. 10, 2020
(86) PCT No.: PCT/EP2020/085553

§ 371 Date: May 17, 2022

(30) Foreign Application Priority Data
Dec. 11, 2019 (EP) 19306626-3

(51) Int. Cl. C08L 95/00

(52) U.S. Cl. CPC C08L 95/00; C08L 2555/60; C08L 2555/34; C08L 2207/322; C08L 2555/50

(57) ABSTRACT

The invention concerns a method for the preparation of a bituminous composition BC comprising the following steps:
a) having an intermediary hydrocarbonated composition IC comprising:
   a hydrocarbonated component selected among bitumen and oils, and
   a hydroxide XOH with X=Na or K, which represents from 15 to 50% by weight of the total weight of the intermediary hydrocarbonated composition IC,
b) introducing the intermediary hydrocarbonated composition IC, into a composition HC of a bitumen, in particular chosen among paving grade bitumen as defined by EN 12591 and polymer modified bitumen as defined by EN 14023.

The intermediary hydrocarbonated composition IC as defined in the invention and its uses are other aspects of the invention.

### FIELD

The present invention relates to the technical field of bituminous compositions. More specifically, it relates to a method for the preparation of bituminous compositions.

### BACKGROUND

The use of bitumen in the manufacture of materials for road and industrial applications has been known for a long time: bitumen is the main hydrocarbon binder used in the field of road construction and civil engineering.

The bitumen can be introduced in the form of a bituminous composition or in the form of a bituminous emulsion with water. The bituminous emulsions are applied at a temperature lower than 80° C., whereas the bituminous compositions are qualified as hot bitumen binder and are applied at higher temperatures, commonly in the range 80 to 240° C. Conventionally, the term “bituminous composition” does not encompass the bituminous emulsions.

Bituminous compositions are used as bituminous binders, in these different applications, providing they fulfill the required mechanical and/or dynamic characteristics. The mechanical properties of the bituminous compositions are determined by standardized tests of the different mechanical characteristics, such as the softening point, the penetrability and the rheological characteristics in predetermined tension.

The bituminous binders are sensitive to oxidation, given the presence of aromatic and unsaturated compounds in the bitumen. As a result, the mechanical properties decrease over time. In road applications, for instance, this decrease of mechanical properties appears as crackings formation, potholes on the roads, granulates discharge. So, it is desired to maintain, as most as possible, the mechanical properties over time of a bituminous binder.

The applicant proposed in its previous patent application WO 2018/206489 to incorporate into a bituminous composition, both a hydroxide XOH, with X=Na, Ca, Mg, Li or K, and at least one amine additive selected from amines, diamines, polyamines, alkyl amido amines, amidopolyamines and imidazolines, for improving the stability over time and over external solicitations, with respect to the mechanical properties of said bituminous composition.

Indeed, the applicant had shown that the addition of a hydroxide XOH like NaOH to a bituminous composition, in combination with an adhesive promoter which corresponds to the additive amine, led to a better resistance to ageing, and in particular that the stability under solicitations of the penetrability at 25° C. measured according to EN 1426 and/or the stability of the ring-and-ball softening temperature measured according to EN 1427 of a bituminous composition were increased.

Preferably, in the previously described method of production, the hydroxide is substantially dry and in finely divided particulate form, when introduced in the composition.

Nevertheless, the storage and the handling of hydroxides XOH like NaOH can raise problems and their instability to water and air may make the method of production of the bitumen compositions difficult to reproduce.

In this context, the present invention proposes another method for producing bituminous compositions with hydroxide XOH like NaOH, which offers ease of processing and a good control of the obtained bituminous compositions.

### SUMMARY OF THE INVENTION

According to a first aspect, the invention concerns a method for the preparation of a bituminous composition BC comprising the following steps:
a) having an intermediary hydrocarbonated composition IC comprising:
   a hydrocarbonated component chosen among oils and bitumen, and
   a hydroxide XOH with X=Na or K, which represents from 15 to 50% by weight of the total weight of the intermediary hydrocarbonated composition IC,
b) introducing the intermediary hydrocarbonated composition IC, into a composition HC of a bitumen, in particular chosen among paving grade bitumen as defined by EN 12591 and polymer modified bitumen as defined by EN 14023.

The intermediary hydrocarbonated composition IC, which is prepared in the method of the invention, is more stable and easier to transport than hydroxide XOH, as hydroxide XOH is protected against both water and CO₂ from air, in said intermediary hydrocarbonated composition IC. So, another advantage of the invention is that the intermediary hydrocarbonated composition IC which is prepared in the method of the invention can be stored under ambient conditions, for instance in an air atmosphere, contrary to hydroxide XOH. Nevertheless, despite the modification in the way of introducing the hydroxide XOH, the method of the invention still leads to bituminous compositions, with similar properties. In particular, bituminous compositions with improved resistance to ageing, as obtained in WO 2018/206489, can be prepared.

According to the invention, the formation of an intermediary hydrocarbonated composition IC, in which the hydroxide XOH with X=Na, or K is present, makes easier the control of the hydroxide XOH, which is present in the final product bituminous composition BC.

According to a preferred embodiment, the hydrocarbonated component has a kinematic viscosity at 60° C. within the range from 50 to 20,000 mm²/s, preferably within the range from 50 to 150 mm²/s. The kinematic viscosity at 60° C. can be measured according to EN 12595. With such a kinematic viscosity, the intermediary hydrocarbonated composition IC can be prepared with classical agitator device, such as paddle agitators. Its subsequent introduction into the composition HC of a bitumen can also be carried out using a conventional agitator device for the manufacture of the bitumen, in particular for the manufacture of hard grade bitumen.

According to another embodiment which can be combined to the previous ones, the hydrocarbonated component has a transmittance of light at a wavelength of 900 nm of at least 0.03%. With such hydrocarbonated components, enough transparent to visible light, it is possible to evaluate and control the hydroxide XOH which is present in the intermediary hydrocarbonated composition IC. In particular, it can be checked that the hydroxide XOH is well dispersed and present in a particulate state and it is possible to control the maximal size of the particles with a microscope (in particular with a visible light microscope), while this control is not possible in the final bituminous composition BC, especially when the bitumen in the bituminous composition BC corresponds to a paving grade bitumen as defined by EN 12591 of grade 20/30, 30/45, 35/50, 40/60, 50/70, 70/100, 100/150 or 160/220, or to a hard grade bitumen as defined in EN 13924-1. In the present invention, “to control” means to check or to verify. So, according to a preferred embodiment of the invention, the method includes a step of checking that the hydroxide XOH is present in a particulate state in the hydrocarbonated composition IC and has a maximal size as defined hereafter. If it is not the case, the hydrocarbonated composition IC will not be used for the preparation of the bituminous composition(s) and another one will be produced.

So, it is possible that the method according to the invention includes, before step b), a step of controlling, for instance by microscopy (in particular by visible light microscopy), that the hydroxide XOH forms particles. This step of controlling can also include checking their maximal size. Advantageously, in the intermediary hydrocarbonated composition IC, the hydroxide XOH forms particles with the maximal size of the particles being equal to 100 μm or less, and preferentially with the maximal size of the particles being equal to 60 μm or less. In particular, in the intermediary hydrocarbonated composition IC, the hydroxide XOH forms particles with at least 80% in number of said particles having a maximal size within the range from 10 to 100 μm, preferably within the range from 20 to 60 μm. This measurement can be carried out by examining by microscopy, and in particular by visible light microscopy, an area where at least five, and preferably at least ten particles of XOH, and in particular a population of ten particles, are(is) visible. More preferably, the average maximal size of the hydroxide particles in the intermediary hydrocarbonated composition IC, is within the range from 10 to 100 μm, preferably within the range from 20 to 60 μm.

As the hydrocarbonated composition IC is stable, the method of the invention has the advantage that its conformity with respect to the size of the XOH particles can be made only one time. After, the hydrocarbonated composition IC can be stored without particular precautions and used after a long period of storage and/or after transport and/or used several times for the preparation of numerous bituminous compositions.

According to preferred embodiments, before step a), the method of the invention comprises the preparation of the intermediary hydrocarbonated composition IC, carried out by mixing the hydrocarbonated component and the hydroxide XOH, preferably at a temperature in the range from 30 to 220° C., preferably from 40 to 190° C. and/or with an agitation in the range from 300 to 800 rpm, preferably in the range from 500 to 650 rpm and/or during a time in the range from 10 to 120 minutes, preferably from 10 to 20 minutes; in particular, for the preparation of the intermediary hydrocarbonated composition IC, the hydroxide XOH is used in the form of particles which are directly introduced into the hydrocarbonated component. Advantageously, the hydroxide XOH forms particles with the maximal size of the particles being equal to 100 μm or less, and preferentially with the maximal size of the particles being equal to 60 μm or less. In particular, the average maximal size of these hydroxide XOH particles is within the range from 10 to 100 μm, preferably within the range from 20 to 60 μm.

According to some embodiments, that can be combined to the preceding ones, before step b), the method of the invention comprises a step of storage of the intermediary hydrocarbonated composition IC, preferably during at least 1 h, and for instance during a time period from 1 to 30 days, at a temperature in the range from 10 to 40° C., preferably in the range from 20 to 30° C. This time of storage corresponds, in particular, to the time spent between the end of the preparation of the intermediary hydrocarbonated composition IC, and its implementation into step b). This storage does not need any precautions and can be done under ambient air.

In another aspect, the invention provides the use of an intermediary hydrocarbonated composition IC comprising:
a hydrocarbonated component chosen among oils and bitumen, and
a hydroxide XOH with X=Na or K, which represents from 15 to 50% by weight of the total weight of the intermediary hydrocarbonated composition IC,
   for improving the ageing properties of a composition HC of a bitumen, in particular chosen among paving grade bitumen as defined by EN 12591 and polymer modified bitumen as defined by EN 14023.

In another aspect, the invention provides the use of an intermediary hydrocarbonated composition IC comprising:
a hydrocarbonated component chosen among oils and bitumen, and
a hydroxide XOH with X=Na K, which represents from 15 to 50% by weight of the total weight of the intermediary hydrocarbonated composition IC,
   for reducing the H₂S emission or the H₂S content of a composition HC of a bitumen, in particular chosen among paving grade bitumen as defined by EN 12591 and polymer modified bitumen as defined by EN 14023.

In these various uses, the intermediary hydrocarbonated composition IC is introduced into the composition HC of bitumen for obtaining a bituminous composition BC.

The intermediary hydrocarbonated compositions IC, as defined in the invention whatever its embodiment, are another aspect of the invention.

The methods, compositions IC and uses, in accordance with the invention, preferably exhibit one or more of the following features, or any combination of these features, or even all of the features below when they are not mutually exclusive:
the hydroxide XOH is NaOH;
the hydrocarbonated component is a soft bitumen, a fluxed or a cut-back bitumen;
the introduced quantity of the intermediary hydrocarbonated composition IC is adjusted for obtaining, in the composition BC, a quantity of hydroxide XOH which represents at most 3% by weight (wt. %), preferably from 0.01 to 2% by weight, and more preferentially from 0.05 to 1% by weight, and more preferentially from 0.1 to 0.7% by weight, of said composition BC;
the hydroxide XOH represents from 15 to 25% by weight of the total weight of the intermediary bituminous composition IC;
the intermediary hydrocarbonated composition IC does not comprise other components than the hydrocarbonated component and the hydroxide XOH;
before its incorporation within the composition HC, the intermediary hydrocarbonated composition IC is heated at a temperature within the range from 30 to 50° C., preferably from 40 to 50° C., advantageously under agitation, in particular in the range from 300 to 1000 rpm, preferably in the range from 400 to 800 rpm;
the incorporation of the intermediary hydrocarbonated composition IC into the composition HC, is carried out, at a temperature in the range from 150 to 220° C., preferably from 160 to 190° C. and/or with an agitation in the range from 100 to 500 rpm, preferably in the range from 200 to 400 rpm and/or during a time in the range from 10 to 180 minutes, preferably from 10 to 20 minutes;
the wt. % of hydroxide XOH in the composition IC is at least 30 times equal to the wt. % of hydroxide XOH in the composition BC, and preferentially at most 100 times equal to the wt. % of hydroxide XOH in the composition BC;
the bituminous composition BC comprises at least one additive which is introduced after the incorporation of the intermediary hydrocarbonated composition IC into the composition HC or is already present into the composition HC, before the incorporation of the intermediary hydrocarbonated composition IC; in particular, the bituminous composition BC comprises an adhesive promoter selected from amines, diamines, polyamines, alkyl amido amines, amidopolyamines and imidazolines, which preferably represents at most 3% by weight, preferably from 0.01 to 2% by weight, and more preferentially from 0.05 to 1% by weight, and more preferably from 0.1 to 0.5% by weight, of said bituminous composition BC and/or the bituminous composition BC comprises an olefinic polymer and an elastomer, preferably a crosslinked elastomer; the olefinic polymer is preferentially chosen among:
   (a) the copolymers of ethylene and glycidyl (meth) acrylate chosen from random and block copolymers, preferably statistic copolymers, of ethylene and a monomer selected from glycidyl acrylate and glycidyl methacrylate, comprising from 50% to 99.7% by weight, preferably from 60% to 95% by weight, more preferably from 60% to 90% by weight of ethylene;
   (b) the terpolymers of ethylene, monomer A and monomer B chosen from random and block terpolymers, preferably statistic terpolymers, of ethylene, a monomer A and a monomer B; the monomer A being selected from vinyl acetate, (C₁-C₆)alkylacrylates and (C₁-C₆)alkylmethacrylates and the monomer B being selected from glycidyl acrylate and glycidyl methacrylate; in particular, the terpolymers ethylene/monomer A/monomer B comprising from 0.5% to 40% by weight, preferably from 5 to 35% by weight, more preferably from 10% to 30% by weight of units resulting from monomer A and from 0.5% to 15% by weight, preferably from 2.5% to 15% by weight of units resulting from monomer B, the rest being formed by units derived from the ethylene;
   (c) the copolymers resulting from the grafting of a monomer B selected from glycidyl acrylate and glycidyl methacrylate, on a polymer substrate; in particular, the polymer substrate comprises a polymer selected from polyethylenes, especially low-density polyethylenes, polypropylenes, random or block copolymers, preferably statistic copolymers, of ethylene and vinyl acetate, random or block copolymer, preferably statistic copolymers, of ethylene and (C₁-C₆)alkylacrylate or (C₁-C₆)alkylmethacrylate; advantageously, the copolymers of ethylene and vinyl acetate or of ethylene and (C₁-C₆)alkylacrylate or (C₁-C₆)alkylmethacrylate comprise from 40% to 99.7% by weight, preferably from 50% to 99% by weight of ethylene; in particular, such grafted copolymers comprise from 0.5% to 15% by weight, preferably from 2.5% to 15% by weight of grafted units resulting from the monomer B.

### BRIEF DESCRIPTION OF THE FIGURES

FIGS. 1 to 3 are pictures made with a visible light microscope of different bituminous compositions IC, obtained in a method according to the invention.

### DETAILED DESCRIPTION

### Definitions

Throughout this specification, unless the context requires otherwise, the word “comprise”, or variations such as “comprises” or “comprising”, will be understood to imply the inclusion of a stated element or method step or group of elements or method steps, but not the exclusion of any other element or method step or group of elements or method steps. According to preferred embodiments, the word “comprise”, or variations such as “comprises” or “comprising” means “consist exclusively of”.

As used in the subject specification, the singular forms “a”, “an” and “the” include plural aspects unless the context clearly dictates otherwise. Thus, for example, reference to “a hydroxide XOH” includes a single hydroxide XOH, as well as two or more hydroxide XOH; reference to “hydrocarbonated component” includes a single hydrocarbonated component, as well as two or more hydrocarbonated components; reference to “the disclosure” includes single or multiple aspects taught by the present disclosure; and so forth. Aspects taught herein are encompassed by the term “invention”. All aspects of the invention are enabled within the width of the claims.

So, in particular, reference to an “hydroxide XOH”, “hydrocarbonated component”, “soft bitumen” and “hard bitumen” includes single entities and combinations/mixtures of two or more of such entities. Nevertheless, according to preferred embodiments, these terms designate a single entity.

The terms “hydroxide” and “hydroxide XOH” are used interchangeably herein.

Unless specified otherwise, the cited European standards are the standards in force on 1 Dec. 2019.

Hydrocarbonated Component

According to the invention, «hydrocarbonated component» refers to a bitumen or an oil and so is a hydrocarbon or a component comprising a hydrocarbon or mainly composed of a hydrocarbon or of a mixture of hydrocarbons. A hydrocarbon consists entirely of hydrogen and carbon atoms and can be saturated or unsaturated, cyclic or acyclic. Alkanes, cycloalkanes, alkenes, alkynes and aromatic hydrocarbons (also known as arenes) are different types of hydrocarbons.

According to the invention, an intermediary hydrocarbonated composition IC comprising such a hydrocarbonated component is provided.

Such hydrocarbonated component can be a bitumen, advantageously a soft bitumen, as defined in particular by EN 12591 (2009 version), for instance referenced as V1500, V3000, V6000 or V12000; or a fluxed or cut-back bitumen, as defined in particular by EN 15322 (2013 version), for instance referenced as Fm 3-225×0, Fm 4-75×0, Fm 4-150×0, Fm 4-300×0, Fm 8×0, Fv 3-30×0, Fv 3-60×0, Fv 3-120×0, Fv 5-60×0, Fv 5-180×0, Fv 8×0 or Fv 9×0.

Examples of suitable hydrocarbonated component, other than bitumen, may be selected from the mineral oils, synthetic oils, flux oils, alkane oils, such as the TOTAL cylinder oil 1000 N. When an oil is used, it is preferentially neutral or basic.

This hydrocarbonated component has, preferably, a kinematic viscosity at 60° C. within the range from 50 to 20,000 mm²/s, preferably within the range from 50 to 150 mm²/s. Such a kinematic viscosity may be measured according to EN 12595.

According to another advantageous feature, the hydrocarbonated component has a transmittance of light at a wavelength of 900 nm of at least 0.03%. The transmittance can be measured using a photometer like the Hach Lange DR 3900, in particular, a 1 cm optical glass cuvette.

### Composition HC of a Bitumen

The composition HC of a bitumen can be any composition of bitumen as known in the art. The composition HC can comprise one or more bitumen. The bitumen that can be used in the invention includes the bitumen of natural origin, those contained in natural deposits of bitumen, natural asphalt or tar sands and the bitumen obtained from the refining of crude oil. The bitumen used in the composition HC is advantageously chosen from the bitumen from the refining of crude oil, particularly from the bitumen containing asphaltenes. The bitumen may be obtained by conventional methods of bitumen manufacturing in a refinery, in particular by direct distillation and/or vacuum distillation of oil.

It is, in particular, standard to carry out the vacuum distillation of the atmospheric residues originating from the atmospheric distillation of crude oil. This manufacturing process consequently corresponds to the sequence of an atmospheric distillation and of a vacuum distillation, the feedstock feeding of the vacuum distillation corresponding to the atmospheric residue. The vacuum residues resulting from the vacuum distillation tower can be used as bitumen. In addition, these residues can optionally be subjected to other treatments in order to modify their mechanical properties, in particular their consistency. The bitumen may be optionally visbroken and/or deasphalted and/or air rectified. The visbreaking corresponds to a conversion process which employs thermal cracking reactions without supplying hydrogen.

The different bitumen obtained by the refining processes can be combined to achieve the best technical compromise in the composition HC.

The bitumen may also be a recycled bitumen or an oxidized bitumen.

The bitumen can be selected from bitumen fulfilling one of the following European standards EN 12591, EN 13924-1 (hard grade) or EN 13924-2 (multigrade).

In particular, the composition HC contains one or more bitumen chosen among paving grade bitumen as defined by EN 12591 (2009 version). The bitumen can be a bitumen of hard or soft grade. For road application, the bitumen is advantageously chosen from bitumen of grades 10/20 to 160/220, for instance of grades 20/30, 30/45, 35/50, 40/60, 50/70, 70/100, 100/150 and 160/220 and from hard grade bitumen as defined in EN 13924-1.

The composition HC may also correspond to a polymer modified bitumen fulfilling the European standards EN 14023.

Advantageously, the compositions HC of bitumen have a penetrability, measured at 25° C. according to EN 1426, between 1 and 300 1/10 mm, preferably between 10 and 100 1/10 mm, more preferably between 30 and 100 1/10 mm.

Advantageously, the compositions HC of bitumen have a ring and ball softening temperature, measured according to EN 1427, preferably less than or equal to 90° C., and preferably between 30° C. and 90° C.

It is particularly advantageous to use the method of the invention, when the bitumen which is present in the composition HC is different from the hydrocarbonated component. According to preferred embodiments:
the composition HC of bitumen has a dynamic viscosity at 60° C. (in particular measured according to EN 12596) of more than 3 Pa·s, preferably of more than 30 Pa·s; and/or,
the composition HC of bitumen has a kinematic viscosity at 60° C. of at least 3,000 mm²/s, preferably of at least 30,000 mm²/s; and/or,
the composition HC of bitumen is characterized by a higher viscosity than the hydrocarbonated component of the intermediary hydrocarbonated composition IC; advantageously, when the hydrocarbonated component has a kinematic viscosity at 60° C. within the range from 50 to 20,000 mm²/s, the composition HC of bitumen has a kinematic viscosity at 60° C. of at least 30,000 mm²/s and when the hydrocarbonated component has a kinematic viscosity at 60° C. within the range from 50 to 150 mm²/s, the composition HC of bitumen has a kinematic viscosity at 60° C. of at least 3,000 mm²/s, and preferentially of at least of at least 30,000 mm²/s; these kinematic viscosities can be measured according to EN 12595; and/or,
the composition HC of bitumen is characterized by a lower transmittance, than the hydrocarbonated component of the intermediary hydrocarbonated composition IC, for instance by a transmittance of light at a wavelength of 900 nm of less than 0.01% in particular, when the hydrocarbonated component has a transmittance of light at a wavelength of 900 nm of at least 0.03%.

Hydroxide

The method of the invention uses a hydroxide XOH, with X=Na or K. It is possible the method according to the invention uses one, or more than one hydroxide XOH.

The purpose of the method of the invention is to provide a bituminous composition BC, according to steps which are easy to implement and which facilitate the control of the characteristics of the final bitumen composition BC. According to a particular embodiment, the method of the invention leads to a bituminous composition BC comprising at most 3% by weight, preferably from 0.01 to 2% by weight, and more preferentially from 0.05 to 1% by weight, and more preferably from 0.1 to 0.7% by weight of the hydroxide XOH with X=Na or K, relative to the total weight of said composition.

The method according to the invention uses NaOH and/or KOH, as hydroxide XOH, and advantageously only NaOH, only KOH or a mixture of NaOH and KOH, as hydroxide XOH.

According to a particular embodiment, the method according to the invention uses NaOH, as hydroxide XOH, and advantageously only NaOH, as hydroxide XOH.

### Other Additives

The present invention can be implemented for the preparation of any type of bituminous compositions BC, especially bituminous compositions for industrial and road applications.

According to a particular embodiment, the method according to the invention implements one or several additives, other than the hydroxide.

Advantageously, the method according to the invention may use, and so the obtained bituminous composition BC may contain, an amine additive as described in WO 2018/206489 which is incorporated by reference. Such an amine additive acts as an adhesive promoter in the final composition BC. Advantageously, it represents at most 3% by weight, preferably from 0.01 to 2% by weight, and more preferentially from 0.05 to 1% by weight, and more preferably from 0.1 to 0.5% by weight, of the bituminous composition BC and so it is introduced in the method according to the invention in such quantities.

In particular, the amine additive is selected from:

Amines of formula (I):

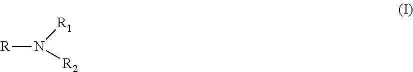

wherein:
R is a saturated or unsaturated, substituted or unsubstituted, optionally branched or cyclic, hydrocarbon radical with 8 to 24 carbon atoms, for example derived from tallow fatty acids, or tall oil fatty acids; and
R₁ and R₂ can be the same or different and are selected from hydrogen or hydrocarbon radical with 1 to 24 carbon atoms; R₁ and R₂ are preferably selected from hydrogen or methyl;

Diamines and polyamines of formula (II):

R—(NH-L)ₙ-NH₂ (II)

wherein:
R has the same meaning as in (I) above,
L represents a linear or branched hydrocarbon radical with 1 to 6 carbon atoms, for instance L is —(CH₂)ₘ— with m=1, 2 or 3 and,
n is an integer greater than or equal to 1, in particular n is an integer from 1 to 6;

Alkyl amido amines of formula (III):

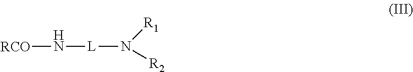

wherein R, R₁, R₂ and L have the same meaning as in (I) and (II), above;

Amidopolyamines of formula (IV) and imidazolines:

RCO—(NH-L)ₚ-NH₂ (IV)

wherein R and L have the same meaning as in (I) and (II) above, and p is an integer greater than or equal to 1, in particular p is an integer from 1 to 10.

Advantageously, the amine additive is selected from amines, diamines, polyamines, alkyl amido amines and amidopolyamines including a fatty chain. According to a specific embodiment, the amine additive is an amidopolyamine including a fatty chain of formula:

RCO—[NH-L]ₚ-NH₂ (IV)

where:

p is an integer greater than or equal to 1, in particular p is an integer from 1 to 10,

L is a linear or branched hydrocarbon radical with 1 to 6 carbon atoms, for instance L is —(CH₂)ₘ— with m=1, 2 or 3,

R is a saturated or unsaturated, substituted or unsubstituted, optionally branched hydrocarbon radical with 8 to 24 carbon atoms.

In particular, the amine additive of the composition is a mixture of amidopolyamines of formula (IV) in which p is an integer from 1 to 10, L is —(CH₂)₂—, and R are the hydrocarbon chains of the fatty acids of tall oil.

The method according to the invention may use, and so the obtained bituminous composition BC may contain, any conventional additive(s) used by the person skilled in the art in bituminous compositions, in particular an elastomer. Preferably, the elastomer is chosen among SB copolymers (block copolymer of styrene and butadiene), SBS (styrene-butadiene block copolymer styrene), SIS (styrene-isoprene-styrene), SBS* (block copolymer styrene-butadiene-styrene star), SBR (styrene-b-butadiene-rubber), EPDM (ethylene propylene diene modified). These elastomers may also be crosslinked by any known method, for example with sulfur according to well-known processes.

According to particular embodiments, the method may use, and so the bituminous composition BC according to the invention may comprise, an olefinic polymer. Preferably, such an olefinic polymer is used in combination with an elastomer and preferentially with an elastomer as previously described. In particular, the olefinic polymer is selected from the group consisting of (a) ethylene/glycidyl (meth)acrylate copolymers; (b) ethylene/monomer A/monomer B terpolymers and (c) copolymers resulting from the grafting of a monomer B on a polymer substrate. In particular, the olefinic polymer is chosen from the groups (a), (b) and (c) consisting of:

(a) the copolymers of ethylene and glycidyl (meth) acrylate chosen from random and block copolymers, preferably statistic copolymers, of ethylene and a monomer selected from glycidyl acrylate and glycidyl methacrylate, comprising from 50% to 99.7% by weight, preferably from 60% to 95% by weight, more preferably from 60% to 90% by weight of ethylene;
(b) the terpolymers of ethylene, monomer A and monomer B chosen from random and block terpolymers, preferably statistic terpolymers, of ethylene, a monomer A and a monomer B; the monomer A being selected from vinyl acetate, (C₁-C₆)alkyl acrylates and (C₁-C₆)alkylmethacrylates and the monomer B being selected from glycidyl acrylate and glycidyl methacrylate; in particular, the terpolymers ethylene/monomer A/monomer B comprise from 0.5% to 40% by weight, preferably from 5 to 35% by weight, more preferably from 10% to 30% by weight of units resulting from monomer A and from 0.5% to 15% by weight, preferably from 2.5% to 15% by weight of units resulting from monomer B, the rest being formed by units derived from the ethylene;
(c) the copolymers resulting from the grafting of a monomer B selected from glycidyl acrylate and glycidyl methacrylate, on a polymer substrate; in particular, the polymer substrate comprises a polymer selected from polyethylenes, especially low-density polyethylenes, polypropylenes, random or block copolymers, preferably statistic copolymers, of ethylene and vinyl acetate, random or block copolymer, preferably statistic copolymers, of ethylene and (C₁-C₆)alkylacrylate or (C₁-C₆)alkylmethacrylate; advantageously, the copolymers of ethylene and vinyl acetate or of ethylene and (C₁-C₆)alkylacrylate or (C₁-C₆)alkylmethacrylate comprise from 40% to 99.7% by weight, preferably from 50% to 99% by weight of ethylene; in particular, such grafted copolymers comprise from 0.5% to 15% by weight, preferably from 2.5% to 15% by weight of grafted units resulting from the monomer B.

The olefinic polymer is preferably selected from the group (b) of terpolymers of ethylene, monomer A and monomer B described above. So, advantageously, the olefinic polymer is selected from random terpolymers of ethylene, a monomer A chosen from (C₁-C₆)alkylacrylates and (C₁-C₆)alkylmethacrylates and a monomer B selected from glycidyl acrylate and glycidyl methacrylate, comprising from 0.5% to 40% by weight, preferably from 5 to 35% by weight, more preferably from 10% to 30% by weight of units resulting from monomer A and 0.5% to 15% by weight, preferably from 2.5% to 15% by weight of units resulting from monomer B, the rest being formed by units resulting from the ethylene.

The amount of the olefinic polymer will be adjusted by the person skilled in the art, depending on the nature of the bitumen used.

According to a particular embodiment, the bituminous composition BC obtained according to the invention comprises, in total, from 0.05% to 15% by weight, preferably from 0.1 to 10% by weight, more preferably from 0.3 to 8% by weight, and preferentially from 0.5 to 6% by weight of conventional additive(s) (in particular corresponding to the total amount of olefinic polymer and elastomer when they are both present) described above relative to the total weight of said composition. So, the method uses quantities of olefinic polymer and elastomer, so as to obtain such a content in the obtained bituminous composition BC.

Advantageously, the final bituminous compositions BC have a penetrability, measured at 25° C. according to EN 1426, between 1 and 300 1/10 mm, preferably between 10 and 100 1/10 mm, more preferably between 30 and 100 1/10 mm.

Advantageously, the final bituminous compositions BC have a ring and ball softening temperature, measured according to EN 1427, preferably less than or equal to 90° C., and preferably between 30° C. and 90° C.

The Steps of the Method for the Preparation of a Bituminous Composition BC

The present disclosure further provides a detailed description of the method of preparation according to the invention, which implements the above described hydrocarbonated component, hydroxide XOH and composition HC of a bitumen, and eventually one or several other additive(s).

The method of the invention includes a step a) of having an intermediary hydrocarbonated composition IC comprising:
a hydrocarbonated component, as defined above, which has advantageously a kinematic viscosity at 60° C. according to EN 12595 within the range from 50 to 20,000 mm²/s, preferably within the range from 50 to 150 mm²/s, and
a hydroxide XOH with X=Na or K, which represents from 15 to 50% by weight of the total weight of the intermediary hydrocarbonated composition IC.

A main advantageous of the use of an intermediary hydrocarbonated composition IC is to freeze the characteristics of the XOH present in the intermediary hydrocarbonated composition IC. These characteristics can be checked one time and after, the intermediary hydrocarbonated composition IC can be handled or transported without precautions, as the XOH is protected, in particular from oxidation reactions. As shown in the examples, as the size of the particles of XOH has an influence on the stability of the final bituminous compositions BC, to ensure that the final bituminous composition will have optimized stability, it is just necessary to check one time the intermediary hydrocarbonated composition IC to be sure, it contains XOH particles with the best suitable size. For instance, a suitable hydrocarbonated composition IC can be prepared in large quantities, and can be used later on different places or for different productions of bituminous compositions. Additionally, obtaining a good repartition of XOH in particles form is easier in the intermediary hydrocarbonated composition IC, than in the final bituminous compositions, considering the respective viscosity of these compositions.

In the intermediary hydrocarbonated composition IC, it is advantageous that the hydroxide XOH is in the form of particles distributed within the hydrocarbonated component. Preferably, the hydroxide XOH is regularly distributed.

Most of the time, in the composition IC, the particles of the hydroxide XOH are not spherical and have irregular forms. The maximal size of a particle, corresponding to its highest dimension, can be measured with a microscope, in particular with a visible light microscope, directly on the composition IC obtained in the method of the invention. Such a measurement is possible, especially, when the hydrocarbonated component has a transmittance of light at a wavelength of 900 nm of at least 0.03%.

The method of the invention may include, before step a), a step of preparing the intermediary hydrocarbonated composition IC, referred as step a′).

Advantageously, before its incorporation into the hydrocarbonated component, the hydroxide XOH is anhydrous and/or its purity is above 99%, in particular when it is introduced in particulate form. This leads to an even better control of the size of the hydroxide XOH particles.

The step a′) may be carried out, by introducing the hydroxide XOH in particulate form or in solution in a suitable solvent, into the hydrocarbonated component. Water and methanol are examples of suitable solvents. The hydroxide XOH may be present in the solution, for instance at a concentration from 10 to 50 wt. % (with respect to the total weight of the solution). A suitable solvent will, for instance, have a boiling point lower or equal to 100° C. at 1013.3 hPa. The solvent will preferentially evaporate spontaneously when the solution of the hydroxide XOH will be incorporated into the hydrocarbonated component.

When such a solution of hydroxide XOH, the formation of particles of XOH and their size can only be checked on the intermediary hydrocarbonated composition IC.

According to a preferred mode, for the preparation of the intermediary hydrocarbonated composition IC, the hydroxide XOH is used in the form of particles which are directly introduced into the hydrocarbonated component. This mode leads to a better control of the size of the particles of hydroxide XOH into the intermediary hydrocarbonated composition IC, as the size is retained after the incorporation.

Advantageously, the hydroxide XOH forms particles with the maximal size of the particles being equal to 100 μm or less, and preferentially with the maximal size of the particles being equal to 60 μm or less. In particular, the average maximal size of the introduced hydroxide particles is within the range from 10 to 100 μm, preferably within the range from 20 to 60 μm. The average maximal size of the particles corresponds to the arithmetic average of the maximal sizes of several particles, preferably of 20 particles. The maximal sizes can be measured by microscopy. Another way to select the size of the introduced hydroxide particles can be to select hydroxide particles with at least 80% in number of said particles having a maximal size within the range from 10 to 100 μm, preferably within the range from 20 to 60 μm. This last measurement which is not the preferred one according to the invention can be obtained on a population of 10, or preferentially, 20 particles. The size of the introduced particles can be adjusted by various techniques of crushing or milling, for instance by using a suitable crushing device, such as an IKA® A11 Mill.

Generally, the preparation of the intermediary hydrocarbonated composition IC is carried out by mixing the hydrocarbonated component and the hydroxide XOH at a temperature in the range from 30 to 220° C., preferably from 40 to 190° C. and/or with an agitation in the range from 300 to 800 rpm, preferably in the range from 500 to 650 rpm and/or during a time in the range from 10 to 120 minutes, preferably from 10 to 20 minutes. The parameters of the mixing and the temperature will be adjusted by the person skilled in the art, with respect to the selected hydrocarbonated component.

According to preferred embodiments, the hydrocarbonated component has a kinematic viscosity at 60° C. within the range from 50 to 20,000 mm²/s, preferably within the range from 50 to 150 mm²/s (in particular, measured according to EN 12595). With such a kinematic viscosity, the mixing of the hydrocarbonated component and the hydroxide XOH for the preparation of the intermediary hydrocarbonated composition IC can be carried out, with classical agitator device, for instance with a paddle agitator.

Most of the time, if needed, the hydrocarbonated component is heated at a temperature where it is in a liquid state, for favouring the regular incorporation of the hydroxide XOH. For instance a temperature just enough to get the hydrocarbonated component melting may be used, when the hydroxide is introduced as a powder. When the hydroxide is introduced as a solution in a solvent, the heating will preferentially be adapted for allowing the spontaneous evaporation of the solvent, simultaneously with its incorporation.

In the intermediary hydrocarbonated composition IC, the quantity of incorporated hydroxide XOH represents from 15 to 50% by weight of the total weight of the intermediary bituminous composition IC, and in particular from 15 to 25% by weight of the total weight of the intermediary bituminous composition IC. The quantity of hydroxide XOH in the intermediary hydrocarbonated composition IC will determine the quantity of the intermediary hydrocarbonated composition IC which will be incorporated in step b), in the composition HC, to obtain the final required quantity of hydroxide XOH, which represents preferably at most 3% by weight, preferably from 0.01 to 2% by weight, and more preferentially from 0.05 to 1% by weight, and more preferentially from 0.1 to 0.7% by weight of the hydroxide XOH with X=Na or K, relative to the total weight of the final bituminous composition BC.

In general, the wt. % of hydroxide XOH in the composition IC is at least 30 times equal to the wt. % of hydroxide XOH in the composition BC, and preferentially at most 100 times equal to the wt. % of hydroxide XOH in the composition BC.

It is possible that, before step b), the method of the invention comprises a step of storage of the intermediary hydrocarbonated composition IC, during at least 1 hour, and for instance during a time period from 1 to 30 days, at a temperature in the range from 10 to 40° C., preferably in the range from 20 to 30° C. and/or under ambient air. The intermediary hydrocarbonated composition IC is satisfactorily stable in these conditions. So, a same prepared composition IC, with specific characteristics, can be used for the preparation of several bituminous compositions BC, which is highly advantageous.

According to preferred embodiments, that can be combined to the preceding ones, before step b), the method of the invention comprises a step of controlling, for instance by microscopy, in particular by visible light microscopy, that the hydroxide XOH forms particles with at least 80% in number of said particles having a maximal size within the range from 10 to 100 μm, preferably within the range from 20 to 60 μm. If this checking confirms that the hydroxide XOH has the advantageous maximal size in the intermediary hydrocarbonated composition IC, it is used in the preparation of a bituminous composition BC. Otherwise, another intermediary hydrocarbonated composition IC may be prepared.

Additionally, when there is no intermediary hydrocarbonated composition IC still available, a new one can be prepared in one operation and on a site having the necessary device particularly for obtaining the required particles size of the hydroxide XOH (for instance MAO A11 Mill). This preparation is very quick (typically 2 or 3 hours) and the prepared intermediary hydrocarbonated composition IC can be sent and transported to the production site of bitumen without particular precautions. This is very advantageous from a logistical point of view.

In step b), the method of the invention provides the incorporation of the intermediary hydrocarbonated composition IC, into a composition HC of a bitumen, in particular chosen among paving grade bitumen as defined by EN 12591 and polymer modified bitumen as defined by EN 14023.

Classically, such incorporation is carried out under heating and mixing.

The composition HC is also generally heated under agitation, before this incorporation. The parameters of the mixing and the temperature will be adjusted by the person skilled in the art, with respect to the selected composition HC, in order to get the melting of said composition

Similarly, before its incorporation within the composition HC, the intermediary hydrocarbonated composition IC is, preferably, heated at a temperature within the range from 30 to 50° C., preferably from 40 to 50° C., advantageously under agitation, in particular in the range from 300 to 1000 rpm, preferably in the range from 400 to 800 rpm and/or during a time in the range from 10 to 120 minutes, preferably from 10 to 20 minutes. A low temperature, preferably from 40 to 50° C. is advantageous, for promoting the control of the XOH particles size. Such a temperature may, in particular, be used when the hydrocarbonated component has a kinematic viscosity at 60° C. within the range from 50 to 20,000 mm²/s, preferably within the range from 50 to 150 mm²/s. Here again, the parameters of the mixing and the temperature will be adjusted by the person skilled in the art, with respect in particular to the selected hydrocarbonated component.

For instance, the incorporation of the intermediary hydrocarbonated composition IC into the composition HC, is carried out, by mixing at a temperature in the range from 150 to 220° C., preferably from 160 to 190° C. and/or with an agitation in the range from 100 to 500 rpm, preferably in the range from 200 to 400 rpm and/or during a time in the range from 10 to 180 minutes, preferably from 10 to 20 minutes. Here again, the parameters of the mixing and the temperature will be adjusted by the person skilled in the art, with respect in particular to the selected components.

Whatever the quantity of incorporated hydroxide XOH in the intermediary bituminous composition IC, the introduced quantity of the intermediary hydrocarbonated composition IC is preferably adjusted for obtaining, in the composition BC, a quantity of hydroxide XOH which represents at most 3% by weight, preferably from 0.01 to 2% by weight, and more preferentially from 0.05 to 1% by weight, and more preferably from 0.1 to 0.7% by weight, of said composition BC.

The composition BC may be the one obtained at the end of step b).

When the composition BC includes one or several additives as described in the paragraph “other additives”, this(ese) additive(s) may be present in the composition HC, before the introduction of the intermediary hydrocarbonated composition IC or added after. It is also possible, that one or several additives is(are) already present and that one or several other additive(s) is(are) added after.

In particular embodiments, the method according to the invention includes, after step b), an additional step c) of addition of an additive, leading to the composition BC.

In particular, when the composition BC comprises an amine additive, as previously described, this amine additive is preferentially introduced in a subsequent step c), carried out after the introduction of the intermediary hydrocarbonated composition IC.

When the composition BC comprises an elastomer and eventually an olefinic additive, as previously described, it (they) is (are) preferentially present in the composition HC, before the introduction of the intermediary hydrocarbonated composition IC.

Bituminous Compositions BC and their Uses

The bituminous compositions obtained according to the method of the invention have the same properties as the bituminous compositions in which a hydroxide XOH is incorporated directly, without the preparation of an intermediary hydrocarbonated composition IC. In other words, the use of the intermediary hydrocarbonated composition IC does not alter the properties of the final bituminous composition BC, but ensure that the characteristics of the introduced hydroxide XOH are constant in the intermediary hydrocarbonated composition IC, as the hydrocarbonated component ensures its protection mainly from oxidation and aggregation.

The bituminous compositions BC obtainable by the methods according to the invention can be used in the fields of road applications or in the fields of industrial applications. Whatever the field of use, the bituminous composition BC can be used as a bituminous binder and is shaped and/or associated with other components under heat. Conventionally, the heating temperature is in the range 80 to 240° C., more preferably in the range of 90 to 230° C.

In road applications, the bituminous composition BC obtainable by the methods according to the invention is, in particular, used for the manufacture of hot bituminous mixes, asphalts or surface coatings. For instance, the bituminous composition BC obtainable by the methods according to the invention may be included in bituminous mixes as materials for the construction and the maintenance of road foundations and their surfacing, and for all road works. Thus, the present invention offers a method of road building comprising combining the bituminous composition BC obtainable by the methods according to the invention with aggregates and/or inorganic and/or synthetic fillers under heat and applying the obtained material to form a part of the road.

The bituminous composition BC obtainable by the methods according to the invention can be employed to prepare a combination with aggregates, advantageously with road aggregates, in particular to form a bituminous mix.

A bituminous mix is understood to mean a mixture of a bituminous composition BC with aggregates and optionally inorganic and/or synthetic fillers. In general, the aggregates and the inorganic and/or synthetic fillers, when they are present, represent from 90 to 96%, preferably from 94.5 to 95% by weight of the bituminous mix and the bituminous BC from 4 to 10%, preferably from 5 to 5.5% by weight of the bituminous mix.

The aggregates are inorganic and/or synthetic aggregates, in particular, recycled milled products, with dimensions of greater than 2 mm, preferably of between 2 mm and 20 mm. Inorganic and/or synthetic fillers are preferably chosen from fines, sand, stone chips and recycled milled products.

As regards the road applications, the invention is also targeted at asphalts as materials for constructing and covering sidewalks. Asphalt is understood to mean a mixture of a bituminous composition BC with inorganic and/or synthetic fillers. Such asphalt comprises a bituminous composition BC obtainable by the methods according to the invention and inorganic fillers, such as fines, sand or stone chips, and/or synthetic fillers. The inorganic fillers are composed of fines (particles with dimensions of less than 0.063 mm), of sand (particles with dimensions of between 0.063 mm and 2 mm) and optionally of stone chips (particles with dimensions of greater than 2 mm, preferably of between 2 mm and 4 mm).

The asphalts exhibit 100% compactness and are mainly used to construct and cover sidewalks, whereas the mixes have a compactness of less than 100% and are used to construct roads. Unlike the mixes, the asphalts are not compacted with a roller when being put in place.

So, the invention also offers new ways of obtaining:
bituminous mixes consisting in a bituminous composition BC obtainable by the methods according to the invention and aggregates, or consisting in a bituminous composition BC, aggregates and fillers which may be inorganic and/or synthetic,
asphalts consisting in a bituminous composition BC obtainable by the methods according to the invention and fillers which may be inorganic and/or synthetic.

In industrial applications, the bituminous composition BC obtainable by the methods according to the invention may be, in particular, used for the manufacture of internal or external coatings.

So, the bituminous BC obtainable by the methods according to the invention may be used in various industrial applications, in particular for preparing a leaktight coating, a membrane or a seal coat.

As regards the industrial applications of the bituminous compositions BC, mention may be made of the preparation of leaktight membranes, of noise-reduction membranes, of insulting membranes, of surface coatings, of carpet tiles or of seal coats.

The present invention also concerns implementations in methods of applying an internal or external coating on a surface, comprising heating the bituminous BC obtainable by the methods according to the invention and applying it to the surface.

The examples below serve to illustrate the invention, but have no limiting character.

### EXAMPLES

### Studied Properties

Size measurements of NaOH particles: the measurement of NaOH particles size was obtained with a visible light microscope (ZEISS axioskop) directly on the composition IC obtained in the method of the invention. The measured size is the greatest size (maximal size) of a particle that can be measured. The average maximal size of the particles before their introduction into the composition IC is the arithmetic average of the measured sizes (maximal sizes) of 20 particles and can be measured with the same microscope.

The needle penetrability was measured at 25° C. according to the standard DIN EN 1426 (Pene 25° C. in the Tables).

The ring and ball softening temperature was measured according to the standard DIN EN 1427 (SP(R+B) in the Tables).

The elastic recovery was measured at 10° C. according to DIN EN 13398.

The storage stability was evaluated according to DIN EN 13399: the bitumen was stored in tubes at 180° C. for 3 days and the ring and ball softening temperature and the needle penetrability were measured, at the top of the tube and at the bottom. If they match, the bitumen is storage-stable.

RTFOT and RTFOT+PAV: The resistance of the bituminous compositions against hardening and ageing was respectively tested according to the standards DIN EN 12607-1 and DIN 12607-1+14769.

The European Standard DIN EN 12607-1 specifies a method for measuring the combined effects of heat and air on a thin film of a bituminous composition in constant renewal (RTFOT). It simulates the hardening undergone by a bituminous composition during mixing before coating applications. The European Standard DIN EN 12607-1+14769 specifies a method for accelerated long-term aging carried out in a pressure aging vessel (RTFOT+PAV). For PAV, standard conditions were used (20 h, 2 MPa, 100° C.).

### Materials

The sodium hydroxide was anhydrous and its purity is above 99% and provided in the form of pellets (CARL ROTH GMBH & Co. KG, Article No 9356.1).

The adhesion promoter H1 was an amine additive: WETFIX BE from Akzo Nobel Surface Chemistry AB (CAS 68910-93-0).

The fluxed bitumen provided by TOTAL under the reference SOFT® BITUMEN had a kinematic viscosity at 60° C. according to EN 12595 of 90 mm²/s. Its transmittance measured at 900 nm with the Hach Lange DR 3900 photometer with a 1 cm optical glass cuvette is 0.1%.

The bitumen AZALT 50/70 had a Penetration measured at 25° C. according the standard DIN EN 1426 of 58 mm/10 and a softening point (R+B) measured according to the standard DIN EN 1427 of 51° C. (grade 50/70). By comparison, the transmittance of this bitumen is 0.001%.

The bitumen AZALT 100/150 had a Penetration measured at 25° C. according the standard DIN EN 1426 of 113 mm/10 and a softening point (R+B) measured according to the standard DIN EN 1427 of 44° C. (grade 100/150).

### Example 1

a) Preparation of the Composition IC1

95.24 g of sodium hydroxide pellets were dissolved into 150 mL of distilled water.

At the same time, 500 g of the fluxed bitumen was heated up to 150° C. in a reactor, under agitation. The reactor had a diameter of d=16 cm and the agitator was a Dissolver plate type (diameter D of the active mechanical part), with D/d=0.4 at 600 rpm. The temperature was controlled using a thermostat. A burette was prepared for transferring the solution of sodium hydroxide into the fluxed bitumen under agitation.

The prepared solution of sodium hydroxide was transferred into the burette and this solution was slowly added to the fluxed bitumen under agitation, during a total time of about 60 minutes. The water phase evaporated immediately. At the end of the addition, the stirring was maintained for 30 minutes. In the obtained composition IC1, the wt. % of NaOH was 16%, based on the total weight of the composition BC1.

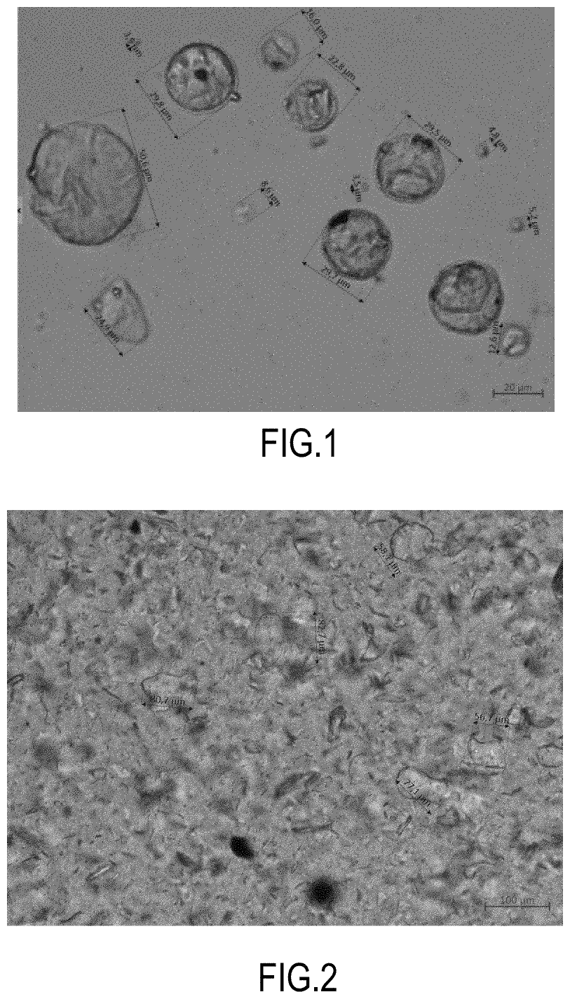

The maximal size of the sodium hydroxide particles into the fluxed bitumen was validated using a microscope and more than 80% of the measured maximal sizes were under 50 μm, as shown on FIG. 1.

b) Preparation of the Bituminous Composition BC1

The above prepared composition IC1 was heated up to 50° C. maximum (viscosity of the fluxed bitumen decreased at higher temperatures which resulted in a higher settling rate of NaOH) under agitation in a reactor with an agitator as described in part a) (D/d=0.4) at 600 rpm to homogenize.

At the same time, 2500 g of the AZALT 50/70 were heated up to 180° C. in a reactor, and stirred using an agitator as described in part a) (D/d=0.4) at more than 400 rpm to homogenize the bitumen. A syringe was used for transferring the prepared composition IC1 directly out of the stirring reactor into the bitumen (3.23 g of composition IC1 for 100 g of AZALT 50/70 bitumen=3.13 wt. % in the final bituminous composition BC1). At the end of the addition of the composition IC1, the stirring was maintained for 30 minutes.

The mixing was maintained during 3 hours under stirring conditions at 600 rpm. The temperature of the mixture was controlled to not underrun 170° C. Samples were regularly taken out of the reactor to measure their current softening point (R+B) and their needle penetrability. The mixing was stopped when both were stabilized.

After, the mixture was cooled down to 160° C. and 5.04 g of the adhesion promoter H1 was added. The mixing was maintained during 20 minutes.

In the final composition BC1, the wt. % of NaOH was 0.5 wt. %, based on the total weight of the composition BC1.

### Example 2

a) Preparation of the Composition IC2

Sodium hydroxide pellets were crushed to a fine powder, using an MAO A11 Mill (IKA-Werke GmbH & Co) at 28000 rpm, during approximately 30 seconds. Afterwards, sodium hydroxide (NaOH) particles were obtained. Their average maximal size measured on 20 particles with the microscope was around 50 μm.

At the same time, 500 g of the fluxed bitumen (the same as the one used in example 1—part a) were heated up to 50° C. in a reactor, under agitation with an agitator as described in part a) of the example 1 (D/d=0.4) at 600 rpm.

95.24 g of the powdered sodium hydroxide was suspended into the fluxed bitumen under stirring and the stirring was maintained for 30 minutes. In the obtained composition IC2, the wt. % of NaOH was 16%, based on the total weight of the composition IC2.

b) Preparation of the Bituminous Composition BC2

A bituminous BC2 was prepared as in example 1 part b), with the use of the above prepared composition IC2, in order to obtain in the final composition BC2, 0.5 wt. % of NaOH, based on the total weight of the composition BC2.

### Comparative Example 2

Sodium hydroxide pellets were crushed to a fine powder, using a MAO A11 Mill (IKA-Werke GmbH & Co) at 28000 rpm, during approximately 30 seconds. Afterwards, sodium hydroxide particles were obtained. Their average maximal size was measured on 20 particles with the microscope and was around 50 μm.

At the same time, 2500 g of the AZALT 50/70 bitumen were heated up to 180° C. in a reactor, and stirred using a SILVERSON high shearing mill at 6000 rpm. The temperature was controlled using a thermostat.

When the bitumen reached a temperature of 180° C., 12.56 g of the powdered sodium hydroxide were added into the stirred bitumen. The final content of sodium hydroxide was 0.5% by weight, considering the total weight of the obtained bitumen composition.

The mixing was maintained during 3 hours under stirring conditions at 6000 rpm. The temperature of the mixture was controlled to not underrun 170° C. Samples were regularly taken out of the reactor to measure their current softening point (R+B) and their needle penetrability. The mixing was stopped when both are stabilized.

After, the mixture was cooled down to 160° C. and 5.04 g of the adhesion promoter H1 was added. The mixing was maintained during 20 minutes.

On the final composition, it was not possible to measure the size of the NaOH particles, with microscopic technique previously described.

The obtained RTFOT and PAV+RTFOT results were comparable, with those obtained with examples 1 and 2.

### Example 3—Study of Different Median Sizes of NaOH Particles and their Effect on the Ageing Behaviour

Different compositions BC were prepared according to example 2, except that the introduced NaOH particles had different average maximal size (450, 180, 70 and 30 μm, referred respectively as compositions BC3a, 3b, 3c and 3d). The different particle sizes were obtained by using different crushing-time or different apparatus:
for 450 μm, the particles were obtained using the IKA® A11 Mill (IKA-Werke GmbH & Co) at 28000 rpm, during just about 3 seconds,
for 180 μm, the particles were obtained using the IKA® A11 Mill (IKA-Werke GmbH & Co) at 28000 rpm, during about 9 seconds,
for 70 μm, the particles were obtained using the IKA® A11 Mill (IKA-Werke GmbH & Co) at 28000 rpm, during about 15 seconds; and
for 30 μm, the particles were obtained using an IKA high speed rotating cone (11 000 rpm, during 2 hours).

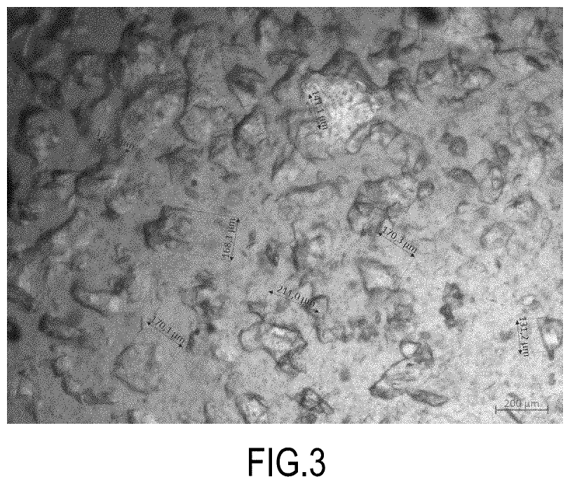

FIGS. 2 and 3 correspond respectively to two pictures obtained by microscopy of the compositions IC obtained with NaOH particles of maximal size around 70 μm and 180 μm.

The obtained RTFOT and PAV+RTFOT results are presented in Table 1 hereafter, in comparison with those obtained with unmodified AZALT 50/70.

TABLE 1

| | Reference | | | | |
|---|---|---|---|---|---|
| | AZALT | BC3a | BC3b | BC3c | BC3d |
| Parameter | 50/70 | 450 μm | 180 μm | 70 μm | 30 μm |
| RTFOT | | | | | |
| Increase SP (R + B) | +7.4° C. | +4.0° C. | +3.6° C. | +4.0° C. | +3.2° C. |
| Retained pene 25° C. | 62% | 72% | 74% | 78% | 79% |
| RTFOT + PAV | | | | | |
| Increase SP (R + B) | +14.2° C. | +12.2° C. | +11.4° C. | +9.0° C. | +9.4° C. |
| Retained pene 25° C. | 40% | 42% | 43% | 49% | 50% |

These results show that the bitumen modified according to the invention have better ageing properties, than the reference. Additionally, the maximal size of the NaOH particles has an exponential effect on the ageing behavior and the best results are obtained with the maximal size of 30 and 70 μm.

### Example 4—Use on Recycling Asphalt

The benefit of the method of the invention was also studied on recycling asphalt.

A composition BC4 (example 4) was prepared according to example 2, except that 2500 g of the AZALT 100/150 were used in step b).

After, the following components were mixed (in wt. %):
49.5% Recycling material (comprising 4.5 wt. % of bitumen binder, SP (R+B): 61° C., pene 25° C.: 34 mm/10)
47.3% aggregate
3.2% composition BC4 of example 4 (SP (R+B): 46.2° C., pene 25° C.: 112 mm/10).

The final composition has the following characteristics:
SP (R+B): 52.3° C.
pene 25° C.: 69 mm/10
Total Bitumen Concentration: 5.4%

As reference, the same asphalt mixture was also prepared with AZALT 100/150.

The asphalt samples were mixed for 3 minutes at 160° C. Afterwards, the bitumen was extracted using toluene out of the asphalt samples. The extracted bitumen were ageing using standard PAV (20 h, 2 MPa, 100° C.) and the results are presented in Table 2 hereafter:

TABLE 2

| | AZALT 100/150 | BC4 |
|---|---|---|
| After extraction | | |
| SP (R + B) | 51.0° C. | 52.3° C. |
| pene 25° C. | 54 mm/10 | 63 mm/10 |
| After PAV | | |
| SP (R + B) | 63.6° C. | 61.0° C. |
| pene 25° C. | 28 mm/10 | 36 mm/10 |

While the needle penetrability at 25° C. obtained with the standard AZALT100/150 decreases down to 41% after ageing, the composition BC4 obtained according to the method of the invention has retained 52% of its needle penetrability at 25° C. Additionally, the increase of SP (R+B) for the composition BC4 obtained according to the method of invention is only +8.7° C., while for the standard AZALT 100/150 it is +12.6° C. These results confirm that the method according to the invention leads to bitumen compositions which have better resistance to ageing, when they are used in asphalt recycling.

### Example 5—Use with Polymer Modified Bitumen

Two compositions BC comprising a polymer modified bitumen were prepared according to the method of the invention:
Composition BC5a (Example 5a) was prepared with (wt. %):
   98.4% of the polymer modified bitumen STYRELF 25/55-55 (comprising 3 wt. % of DYNASOL 1205 which is a SBR Polymer),
   1.4% of a composition IC5a comprising 32 wt. % of NaOH prepared according to example 2-step a), except that the quantity of NaOH was modified,
   0.2% of the adhesion Promoter H1;
Composition BC5b (Example 5b) was prepared with (wt. %):
   96.7% of the polymer modified bitumen STYRELF 65/105-80 (comprising 5 wt. % of LG 501 Luprene which is a SBS Polymer),
   3.1% of a composition IC2 comprising 16 wt. % of NaOH prepared according to example 2-step a),
   0.2% of the adhesion promoter H1.

The preparation of composition BC5a and BC5b was carried out as in Example 1—step b): The above mentioned composition IC was heated up to 50° C. maximum under agitation in a reactor with an agitator as described in part a) (D/d=0.4) at 600 rpm to homogenize.

At the same time, the required quantity of the polymer modified bitumen was heated up to 180° C. in a reactor, and stirred using an agitator as described in example 1—part a) (D/d=0.4) at more than 400 rpm to homogenize the bitumen. A syringe was used for transferring the corresponding composition IC directly out of the stirring reactor into the bitumen. At the end of the addition of the composition IC, the stirring was maintained for 30 minutes.

The mixing was still maintained during 3 hours under stirring conditions at 600 rpm. After, the mixture was cooled down to 160° C. and 5.04 g of the adhesion promoter H1 is added. The mixing was maintained during 20 minutes.

In the final compositions BC5a and BC5b, the wt. % of NaOH was 0.5 wt. %, based on the total weight of the composition BC5a and BC5b, respectively.

The characteristics of the obtained bitumen, in comparison with the same polymer modified bitumen, without the addition of the composition IC and the adhesion Promoter H1 are presented in Table 3a hereafter for composition BC5a and Table 3b for composition BC5b:

TABLE 3a

| | STYRELF | |
|---|---|---|
| Parameter | 25/55-55 | BC5a |
| SP (R + B) | 60.8° C. | 65.6° C. |
| pene 25° C. | 45 mm/10 | 47 mm/10 |
| RTFOT aging | | |
| SP (R + B) | 65.6° C. | 69.8° C. |
| Difference SP (R + B) | +4.8° C. | +4.2° C. |
| pene 25° C. | 35 mm/10 | 41 mm/10 |
| Retained pene 25° C. | 77% | 87% |
| RTFOT + PAV aging | | |
| SP (R + B) | 79.4° C. | 77.0° C. |
| Difference SP (R + B) | +18.6° C. | +11.4° C. |
| pene 25° C. | 20 mm/10 | 28 mm/10 |
| Retained pene 25° C. | 44% | 60% |
| Storage stability | | |
| Difference SP (R + B) | 0.2° C. | 0.6° C. |
| Difference pene 25° C. | 1 mm/10 | 0 mm/10 |

TABLE 3b

| | STYRELF | |
|---|---|---|
| Parameter | 65/105-80 | BC5b |
| SP (R + B) | 85.5° C. | 87.5° C. |
| pene 25° C. | 98 mm/10 | 93 mm/10 |
| Elastic recovery 10° C. | 88% | 88% |
| RTFOT aging | | |
| SP (R + B) | 87.5° C. | 84.5° C. |
| Difference SP (R + B) | +2.0° C. | −3.0° C. |
| pene 25° C. | 65 mm/10 | 74 mm/10 |
| Retained pene 25° C. | 66% | 80% |
| Elastic Recovery 10° C. | 85% | 84% |
| RTFOT + PAV aging | | |
| SP (R + B) | 90.0° C. | 84.5° C. |
| Difference SP (R + B) | +4.5° C. | -3.0° C. |
| pene 25° C. | 40 mm/10 | 50 mm/10 |
| Retained pene 25° C. | 41% | 54% |
| Storage stability | | |
| Difference SP (R + B) | 0.5° C. | 1.0° C. |
| Difference pene 25° C. | 2 mm/10 | 1 mm/10 |

For both polymer types, the results after RTFOT and RTFOT+PAV were significantly improved, when a bitumen composition prepared by the method of the invention is used. The polymer network is not affected by the addition of NaOH, as the same elastic recovery is obtained.

### Example 6—Resistance Against Cold Cracking

Samples of a standard AZALT 50/70 and of a modified bitumen obtained according to example 2 were studied with a method for simulated ageing on granulated asphalt mixtures. This method allows evaluating the resistance against cold cracking regarding the aging behaviour: thermal stress restrained specimen test and uniaxial tensile test according to “TP Asphalt-StB, 46 A” (Technische Prüfvoschriften Für Asphalt, FGSV, august 2013). The modified binder remains in the same “frost zone” (III), while the original binder moved from zone III to II. It can be concluded that the modified bitumen is more resistant to cold cracking.

1. A method for the preparation of a bituminous composition BC comprising the following steps:
a) having an intermediary hydrocarbonated composition IC comprising:
a hydrocarbonated component chosen among oils and bitumen, and
a hydroxide XOH with X=Na or K, which represents from 15 to 50% by weight of the total weight of the intermediary hydrocarbonated composition IC,
b) introducing the intermediary hydrocarbonated composition IC, into a composition HC of a bitumen, in particular chosen among paving grade bitumen as defined by EN 12591 and polymer modified bitumen as defined by EN 14023.

2. The method according to claim 1, wherein the hydrocarbonated component has a kinematic viscosity at 60° C. within the range from 50 to 20,000 mm²/s, preferably within the range from 50 to 150 mm²/s.

3. The method according to claim 1 wherein the hydrocarbonated component has a transmittance of light at a wavelength of 900 nm of at least 0.03%.

4. The method according to claim 3, wherein, before step b), it comprises a step of controlling, for instance by microscopy, in particular by visible light microscopy, the hydroxide XOH forms particles and to check their maximal size.

5. The method according to claim 1, wherein in the intermediary hydrocarbonated composition IC, the hydroxide XOH forms particles with the maximal size of the particles being equal to 100 μm or less, and preferentially with the maximal size of the particles being equal to 60 μm or less, or the hydroxide XOH forms particles with at least 80% in number of said particles having a maximal size within the range from 10 to 100 μm, preferably within the range from 20 to 60 μm, or the hydroxide XOH is in the form of particles of an average maximal size within the range from 10 to 100 μm, preferably within the range from 20 to 60 μm, the average maximal size of the particles being the arithmetic average of the maximal sizes of 20 particles measured with a microscope.

6. The method according to claim 1, wherein the hydroxide XOH is NaOH.

7. The method according to claim 1, wherein the hydrocarbonated component is a soft bitumen, a fluxed or a cut-back bitumen.

8. The method according to claim 1, wherein the introduced quantity of the intermediary hydrocarbonated composition IC is adjusted for obtaining, in the composition BC, a quantity of hydroxide XOH which represents at most 3% by weight, preferably from 0.01 to 2% by weight, and more preferentially from 0.05 to 1% by weight, and more preferentially from 0.1 to 0.7% by weight, of said composition BC.

9. The method according to claim 1, wherein the intermediary hydrocarbonated composition IC does not comprise other components than the hydrocarbonated component and the hydroxide XOH.

10. The method according to claim 1, wherein:
before its incorporation within the composition HC, the intermediary hydrocarbonated composition IC is heated at a temperature within the range from 30 to 50° C., preferably from 40 to 50° C., advantageously under agitation, in particular in the range from 300 to 1000 rpm, preferably in the range from 400 to 800 rpm; and
the incorporation of the intermediary hydrocarbonated composition IC into the composition HC, is carried out, at a temperature in the range from 150 to 220° C., preferably from 160 to 190° C., with an agitation in the range from 100 to 500 rpm, preferably in the range from 200 to 400 rpm and during a time in the range from 10 to 180 minutes, preferably from 10 to 20 minutes.

11. The method according to claim 1, wherein, before step a), it comprises the preparation of the intermediary hydrocarbonated composition IC, preferably carried out by mixing the hydrocarbonated component and the hydroxide XOH at a temperature in the range from 30 to 220° C., preferably from 40 to 190° C., with an agitation in the range from 300 to 800 rpm, preferably in the range from 500 to 650 rpm and during a time in the range from 10 to 120 minutes, preferably from 10 to 20 minutes.

12. The method according to claim 11, wherein, for the preparation of the intermediary hydrocarbonated composition IC, the hydroxide XOH is used in the form of particles of an average maximal size within the range from 10 to 100 μm, preferably within the range from 20 to 60 μm, which are directly introduced into the hydrocarbonated component, the average maximal size of the particles being the arithmetic average of the maximal sizes of 20 particles measured with a microscope, or the hydroxide XOH is used in the form of particles which are directly introduced into the hydrocarbonated component, with the maximal size of the particles being equal to 100 μm or less, and preferentially with the maximal size of the particles being equal to 60 μm or less.

13. The method according to claim 1, wherein the wt. % of hydroxide XOH in the composition IC is at least 30 times equal to the wt. % of hydroxide XOH in the composition BC, and preferentially at most 100 times equal to the wt. % of hydroxide XOH in the composition BC.

14. The method according to claim 1, wherein, before step b), it comprises a step of storage of the composition IC, during at least 1 hour, and for instance during a time period from 1 day to 30 days, at a temperature in the range from 10 to 40° C., preferably in the range from 20 to 30° C.

15. The method according to claim 1, wherein the bituminous composition BC comprises at least one additive which is introduced after the incorporation of the intermediary hydrocarbonated composition IC into the composition HC or which is already present into the composition HC, before the incorporation of the intermediary hydrocarbonated composition IC.

16. The method according to claim 15, wherein the bituminous composition BC comprises an adhesive promoter selected from amines, diamines, polyamines, alkyl amido amines, amidopolyamines and imidazolines, which preferably represents at most 3% by weight, preferably from 0.01 to 2% by weight, and more preferentially from 0.05 to 1% by weight, and more preferentially from 0.1 to 0.5% by weight, of said bituminous composition BC.

17. The method according to claim 15, wherein the bituminous composition BC comprises an olefinic polymer and an elastomer, preferably a crosslinked elastomer.

18. The method according to claim 17, wherein the olefinic polymer is chosen among:
(a) the copolymers of ethylene and glycidyl (meth)acrylate chosen from random and block copolymers, preferably statistic copolymers, of ethylene and a monomer selected from glycidyl acrylate and glycidyl methacrylate, comprising from 50% to 99.7% by weight, preferably from 60% to 95% by weight, more preferably from 60% to 90% by weight of ethylene;
(b) the terpolymers of ethylene, monomer A and monomer B chosen from random and block terpolymers, preferably statistic terpolymers, of ethylene, a monomer A and a monomer B; the monomer A being selected from vinyl acetate, (C₁-C₆)alkylacrylates and (C₁-C₆)alkylmethacrylates and the monomer B being selected from glycidyl acrylate and glycidyl methacrylate; in particular, the terpolymers ethylene/monomer A/monomer B comprising from 0.5% to 40% by weight, preferably from 5 to 35% by weight, more preferably from 10% to 30% by weight of units resulting from monomer A and from 0.5% to 15% by weight, preferably from 2.5% to 15% by weight of units resulting from monomer B, the rest being formed by units derived from the ethylene;
(c) the copolymers resulting from the grafting of a monomer B selected from glycidyl acrylate and glycidyl methacrylate, on a polymer substrate; in particular, the polymer substrate comprises a polymer selected from polyethylenes, especially low-density polyethylenes, polypropylenes, random or block copolymers, preferably statistic copolymers, of ethylene and vinyl acetate, random or block copolymer, preferably statistic copolymers, of ethylene and (C₁-C₆)alkylacrylate or (C₁-C₆)alkylmethacrylate;
advantageously, the copolymers of ethylene and vinyl acetate or of ethylene and (C₁-C₆) alkylacrylate or (C₁-C₆)alkylmethacrylate comprise from 40% to 99.7% by weight, preferably from 50% to 99% by weight of ethylene; in particular, such grafted copolymers comprise from 0.5% to 15% by weight, preferably from 2.5% to 15% by weight of grafted units resulting from the monomer B.

19-20. (canceled)

21. An intermediary hydrocarbonated composition IC comprising:
a hydrocarbonated component chosen among oils and bitumen, and
a hydroxide XOH with X=Na K, which represents from 15 to 50% by weight of the total weight of the intermediary hydrocarbonated composition IC.
